(19) United States
(12) Patent Application Publication
(10) Pub. No.: US 2026/0368593 A1
(43) Pub. Date: Nov. 19, 2026

(54) Unknown

(71) Applicant: COMMISSARIAT À L'ENERGIE ATOMIQUE ET AUX ENERGIES ALTERNATIVES, PARIS (FR)

(72) Inventors: Jean-Baptiste CASANOVA, GRENOBLE (FR); Franck BADETS, GRENOBLE (FR); Quentin SCHMIDT, GRENOBLE (FR); Baptiste JADOT, GRENOBLE (FR); Yvain THONNART, GRENOBLE (FR)

(21) Appl. No.: 19/672,439

(22) Filed: May 8, 2026

(30) Foreign Application Priority Data
May 14, 2025 (FR) 2505119

(51) Int. Cl. G06N 10/40; G06N 10/20

(52) U.S. Cl. CPC G06N 10/40; G06N 10/20

(57) ABSTRACT

A quantum device includes a plurality of spin qubits, a cryostat containing the qubits, electrometers each coupled to one qubit of the plurality of qubits in order to extract, for each qubit, a read-out signal of a current state of the qubit, a voltage generation module generating a plurality of voltages for exciting the electrometers with modulations specific to each electrometer, and a transmission line for transmitting an aggregated signal originating from the electrometers, the aggregated signal being processed by a demultiplexing module of the quantum device in order to recognize, through demodulation, the current states of the qubits of the plurality of qubits. The voltage generation module generates periodic sequences clocked at a reference frequency, with the generated periodic sequences being distinct from one another and being used to excite the qubits of the plurality of qubits in a differentiated manner, the demultiplexing module accessing the current states of the qubits using the reference frequency and the periodic sequences.

### CROSS-REFERENCE TO RELATED APPLICATION

This application claims priority to foreign French patent application No. FR 2505119, filed on May 14, 2025, the disclosure of which is incorporated by reference in its entirety.

### FIELD OF THE INVENTION

Quantum processor or component systems for manipulating cubits include control and read-out electronics that can assume the form of a microelectronic circuit, which must have an interface with the qubits. Systems including tens or hundreds of physical qubits, or even many more, are explored.

### BACKGROUND

The aim is to generate logical qubits, having a coherence time and therefore an error rate allowing the manipulation and reading thereof to be conducted within reasonable times.

Among the available solutions, one of the most popular avenues involves assembling several of these physical qubits in order to form a logical qubit. Depending on the qubit technology that is used, and therefore on the intrinsic error rate of the qubits, the number of physical qubits required to produce a logical qubit varies by several orders of magnitude and requires, in some scenarios, a complete system of several thousand or even millions of physical qubits.

Therefore, the reading interface must be able to manage several million physical qubits, and this is obviously a considerable challenge, irrespective of the qubit technology. The multiplexing technique is used, which involves passing several items of information through a single transmission medium. Several proposals from the prior art deal with this problem and propose multiplexing solutions adapted to the desired read-out time (1/Fread). The multiplexing can be temporal, which involves reading the various elements of a set one after the other. The multiplexing also can be frequency multiplexing, which involves superimposing the signals originating from several elements of a set within a single signal, each element of the set having its own frequency, and then differentiating them using a frequency analysis. This then raises the question of the bandwidth (BW) for such a system, as well as the frequency interval available between each element (ΔF). These constraints define the multiplexing capability of a system. The number of elements that can be multiplexed N is actually equal to the ratio between the width BW of the bandwidth and the spectral spacing ΔF available between two multiplexed elements: N=BW/ΔF.

Frequency modulation is considered for reading superconducting qubits and spin qubits. A similar method proposes increasing the spectral compactness of the multiplexing, by assigning an identical frequency to several elements to be multiplexed, while differentiating them by phase. This provides the possibility of multiplexing signals numbering N=MBW/ΔF, where M is the number of different phases for which the multiplexing capability increases linearly for a given BW and ΔF if the frequency space is fully used and each frequency is distributed over M phases.

Within this context, the present document relates to a new multiplexing method for reading a large number of qubits. The invention proposes examining the various qubits of the system at a single frequency, with a digital square-wave signal, and differentiating the qubits by digital codes specific to each of them.

The prior art currently proposes various reading and therefore multiplexing systems that are used with various qubit technologies.

Reading methods represented in the field relating to this patent are based on a spin-charge conversion. This conversion allows the state of the qubit (|1> or |0>) to be translated into an amount of charge in a detector. To achieve this effect, a detector is electrostatically coupled to the qubit and the detector is connected to the reading electronics.

Technologies based on superconductors or spin qubits sometimes use reflectometry to read the state of the qubits. Reflectometry is a reading method based on coupling between a radiofrequency resonator (LC) and a qubit. The state of the qubit varies an electrical capacitance, called quantum capacitance, in the resonator by a few tens or even hundreds of attofarads as a function of the state of the qubit. This quantum capacitance is a quantity of the detector. It therefore forms part of the resonator dedicated to reading, and allows an image of the state of the qubit to be obtained. A high frequency signal is sent to the input of the read-out resonator and, depending on the value of the qubit, the capacitance shifts or does not shift the resonant frequency of the resonator. This results in a change in the reflection of the incident signal and therefore a change in the amplitude and the phase of the reflected signal.

Another approach, which in this case is mainly used with spin qubits, is read-out of charge. The detector coupled to the qubit experiences a variation in its conductance as a function of the excitation of the qubit. If the detector is then correctly biased in a SET (Single-Electron Transistor) mode, the variation in the state of the qubit can cause the state of the SET to shift to a Coulomb peak. This results in a current A for the |1> state and a current B for the |0> state. Ideally, the current A can be greater than one nA and the current B is almost equal to 0.

In the article by A. Ruffino et al., entitled “A cryo-CMOS chip that integrates silicon quantum dots and multiplexed dispersive readout electronics”, Nat. Electron, Vol. 5, No. 1, pp. 53-59, December 2021, a reflectometry multiplexed read-out was described. The article sets forth a 3×3 matrix of quantum elements (quantum dots). Integrated inductors can be connected to separate quantum dots via voltages applied to the gates of transistors. These principles require as many inductors as elements to be read, and moreover very precise frequencies must be generated hot, which does not allow scaling.

In the article by H. Fuketa et al., entitled “A Cryogenic CMOS Current Integrator and Correlation Double Sampling Circuit for Spin Qubit Readout”, IEEE Trans. Circuits Syst. Regul. Pap., Vol. 70, No. 12, pp. 5220-5228, December 2023, a current integration read-out circuit allows the read-out time of qubits to be reduced, allows the consumption to be reduced and allows the reading performance capabilities to be improved compared to a room temperature electronics construction. This circuit is used within the context of a read-out of charge. The circuit initially integrates the current supplied by the SET and then, using a comparator, determines whether a current has passed through the SET, which translates the state of the qubit. However, the circuit consumes a significant amount of power, which does not allow the transition to scaling.

Documents FR 3117475 A1 and “Compact frequency multiplexed readout of silicon quantum dots in monolithic FDSOI 28 nm technology”, by Schmidt et al., arXiv: 2410.22565, October 2024, disclose a frequency multiplexed read-out with a read-out of charge by a single-electron transistor (SET) that is used as an electrometer and that transmits a current as a function of the state of the qubit it is coupled with. A frequency is associated with each SET and therefore with each qubit, and the currents of the SETs are summed before the sum is amplified and demodulated. The state of each qubit is retrieved by a frequency analysis. The system requires either voltage transformation or current processing. The use of a TIA is proposed in order to transition from currents to voltages, while amplifying the signal.

Patent application FR 3150327 A1 discloses a phase multiplexing method with direct coding on qubits for the multiplexed reading of SETs, thereby allowing greater multiplexing density. This document discloses assigning a specific phase to each SET of a group of SETs. This allows the same frequency to be assigned to different SETs with a different phase. Modulation schemes then can be applied to the multiplexing of SETs and allow a transition to scaling. In the ideal case where the TIA has a fixed bandwidth (BW), a spectral spacing (ΔF) for each frequency and M phases, the number of qubits that can be multiplexed changes from N=BW/ΔF to N=M BW/ΔF. A QAM modulation was carried out on silicon, using the principles developed in this document.

The aforementioned embodiments show that the various known multiplexing techniques for reading qubits require components in numbers proportional to the number of qubits to be multiplexed. Reflectometry, which allows frequency multiplexing, requires as many inductors as frequencies, as well as the generation of a signal containing all the frequencies. Integrator-based solutions do not allow any other form of bulk reading than the sequential reading of qubits, which does not constitute parallel reading, as intended. Finally, the frequency and phase multiplexing schemes associated with a read-out of charge allow an amplifier to be pooled for N qubits, but the N phase-shifted frequencies must be generated and conveyed to the qubits.

### Features and Advantages of the Invention

In order to allow parallel reading of a large number of single-electron transistors or more broadly of electrometers coupled to qubits in order to read their states, a quantum device is proposed comprising a plurality of spin qubits, a cryostat containing said qubits, electrometers each coupled to one qubit of the plurality of qubits in order to extract, for each qubit, a read-out signal of a current state of the qubit, a voltage generation module generating a plurality of voltages for exciting said electrometers with modulations specific to each electrometer, and a transmission line for transmitting an aggregated signal originating from the electrometers, said aggregated signal being processed by a demultiplexing module of the quantum device in order to recognise, through demodulation, the current states of the qubits of the plurality of qubits.

Remarkably, the voltage generation module generates periodic sequences clocked at a reference frequency, with said generated periodic sequences being distinct from one another and being used to excite the qubits of the plurality of qubits in a differentiated manner, with the demultiplexing module accessing the current states of the qubits using said reference frequency and said periodic sequences.

### SUMMARY OF THE INVENTION

Thus, the present document proposes a new method for reading qubits by simultaneous digital addressing of single-electron transistors, through a new approach for multiplexing signals during the read-out of charge using digital codes. The generation of several codes is proposed, which codes are used to modulate each single-electron transistor independently. Unlike frequency and phase modulation, the digital signals are generated at a common frequency. Thus, a single signal needs to be brought into the cryostat from room temperature for multiplexing. This signal is the clock frequency of the digital controller. Therefore, the multiplexing is, in some embodiments, generated within the cryostat, and therefore only a few cables, compared to the prior art, need to pass through the temperature enclosure.

According to optional and advantageous features:
the periodic sequences are, optionally and advantageously, Hadamard sequences, Gold sequences, or Kasami sequences. Alternatively, other ways of generating orthogonal sequences, such as pseudo-noise, are used.

The periodic sequences can be generated, as mentioned above, by the voltage generation module inside the cryostat.
the demultiplexing module can proceed, sequence-by-sequence, optionally at the same time (all the sequences can be processed at the same time), by integrating the aggregated signal multiplied by the periodic sequence over a read-out time common to the various sequences, in order to recognise the presence or the absence of the periodic sequence in the aggregated signal.
the aggregated signal can be previously processed by a digitising module for the purposes of demodulation by the demultiplexing module. Demodulation directly on the signal is implemented in another embodiment.
or the aggregated signal can be demultiplexed inside the cryostat by an analogue circuit (400) comprising a capacitor and a comparator for each qubit.
the quantum device comprises voltage levelling modules for matching voltages delivered by a digital voltage generator of the voltage generation module to the biasing points of the electrometers, with each levelling module comprising a controlled switch for alternating between two DC voltages, or a resistive or capacitive voltage divider.
the voltage generation module generates digital codes on two levels.
the voltage generation module optionally and advantageously comprises one shift register per qubit of the plurality of qubits and therefore per associated electrometer for the purposes of generating the various periodic sequences. Other embodiments do not include a shift register.
the voltage generation module is pooled for several pluralities of qubits each associated with a specific aggregated signal.
the qubits and the electrometers are optionally and advantageously single-electron transistors.
the qubits and the electrometers are constructed face-to-face in a semiconductor material.
the generated periodic sequences are delivered to the demultiplexing module in the cryostat by the voltage generation module, or outside the cryostat by a module synchronised with the voltage generation module.
the reference frequency is delivered to the voltage generator by a clock signal generator outside the cryostat.
before being transmitted to the demultiplexing module, the aggregated signal is amplified by a chain placed on one temperature stage or distributed over several temperature stages of the cryostat.

### BRIEF DESCRIPTION OF THE DRAWINGS

FIG. 1 shows, in one embodiment, the impact of the coupling between the qubit and the SET and the image of the current once it has been modulated.

FIG. 2 shows a read-out diagram per spread sequence, according to one embodiment of the invention.

FIG. 3 shows an example of communication with on-off keying (OOK) modulation for four qubits.

FIG. 4 shows an example of a sequence of the principles of FIG. 3 in a scenario.

FIG. 5 shows an example of a block diagram of 16 length shift registers for generating spread sequences.

FIG. 6 shows an example of a matrix used in one embodiment of the invention.

FIG. 7 shows an example of a device for producing a single-electron transistor and a qubit.

FIG. 8 shows an example of a map of a two-gate single-electron transistor.

FIG. 9A shows an example of digital modulation of a single-electron transistor with external voltages.

FIG. 9B shows details of the production of another example of digital modulation of a single-electron transistor with external voltages.

FIG. 9C shows details of the production of another example of modulation of a single-electron transistor with external voltages. The circuit that is shown ensures that the external signal has the correct dynamics for the system, using attenuators.

FIG. 10 shows the locations of the gain blocks in various variants.

FIG. 11 shows an example of modulation.

FIG. 12 shows the signals output from a single-electron transistor.

FIG. 13 shows signals during the demodulation of a single-electron transistor.

FIG. 14 shows cumulative signals during the demodulation of a plurality of single-electron transistors.

FIG. 15 shows an example of a hot demodulation chain.

FIG. 16 shows an example of a cold analogue demodulation chain.

FIG. 17 shows an example of a serial link to the outside of the cryostat.

### DETAILED DESCRIPTION

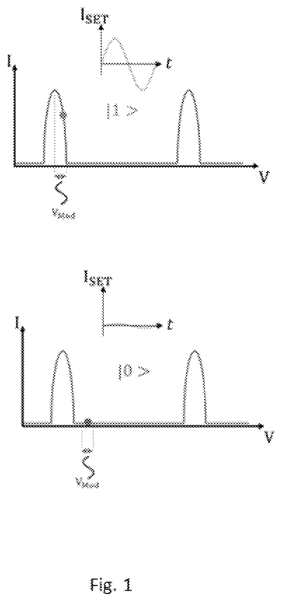

FIG. 1 shows two representations (main graphs in the upper and lower parts of the figure), for a single-electron transistor, of the output intensity of the transistor (I on the ordinate) as a function of the voltage (V on the abscissa) at the gate of this transistor. Coulomb peaks of the transistor can be seen, which are separated from each other by a few tens of millivolts and are a few millivolts wide.

During operation, the gate voltage V is modulated within a small interval around a mean value, as shown in the two parts of the figure indicating Vmod. This mean value and the modulation around this mean value are fixed.

In the upper part of the figure, the qubit is at the value |1> and the mean voltage value is within the width of one of the two Coulomb peaks of the transistor, close to its maximum. The transistor is then on and delivers a current indicated in the inset of the upper part, on the ordinate, as a function of time on the abscissa: the outgoing current reproduces the evolution over time of the voltage applied to the gate.

In the lower part of the figure, the qubit is at the value |0> and the mean voltage value is outside each of the Coulomb peaks of the transistor. The transistor is then off and delivers a current indicated on the ordinate in the insert as a function of time on the abscissa, with this current being close to 0 A and in any extreme case much closer to 0 A than the extremes of the current obtained when the qubit is at the value |1>.

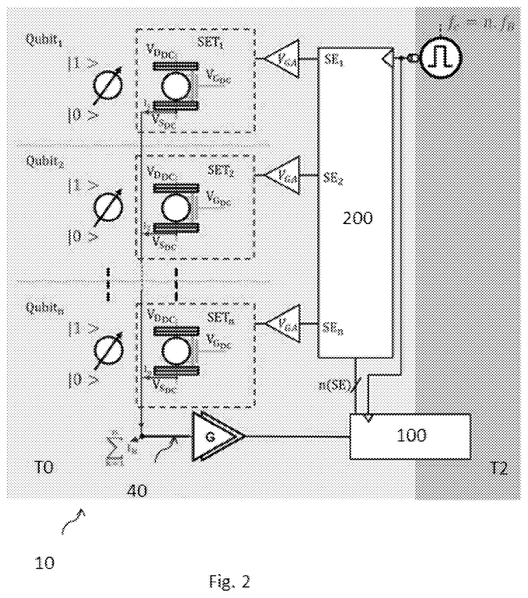

FIG. 2 shows a set of n spin qubits (with n being an integer) denoted Qubit1, Qubit2, . . . Qubitn, which notably can assume the values |0> and |1>. These qubits are placed in a very low temperature enclosure, at a temperature TO of a cryostat 10.

Each qubit is coupled to a single-electron transistor (SET) for the purposes of reading the state of the corresponding qubit. The transistors are denoted SET1, SET2, . . . , SETn. They are placed as close as possible to the qubits, and therefore in the temperature stage TO.

Each transistor has a drain receiving a constant voltage VD (DC), which can be ground. Each transistor has a gate that receives a modulated voltage VG (DC). Each transistor also has a source that delivers a source current I1, I2, . . . In. The currents of the sources of the various transistors are summed on a row 40, in this case a single row, and in any case common to the n transistors. This row comprises an amplifier or a series of amplifiers, denoted G. This amplification chain in this case is at the temperature T0. It conveys the signal resulting from the sum of the read-out signals of the various qubits to a demodulation module 100, which is placed entirely at the temperature T0, or partly at the temperature T0, and partly at a higher temperature T2 (T2>T0). The demodulation module is responsible for extracting, from the amplified signal, the signals of the various qubits that have been multiplexed in a single electric current. The demodulation is either digital or analogue.

Several digital sequences are generated cold, i.e. in the temperature stage T0, by the digital controller 200 and are used to modulate each transistor independently of the others. The digital sequences are generated at a single frequency, based on a single clock signal. A common clock signal is actually generated hot, i.e. at the temperature T2, and is lowered in the cryostat from the ambient temperature in order to generate sequences by means of the digital controller 200. This common signal is a clock frequency fc (chip frequency, inverse of the chip time and equal to n times the bit frequency, namely the inverse of the bit time). The digital sequences are referred to as spread sequences (SE). There is a different one for each transistor. These spread sequences are the digital codes associated with each qubit read-out transistor that allow them to be identified in the demodulation process.

The spread sequences sent to each single-electron transistor allow the output currents to be modulated, which are modulated by the state of the qubit the transistor is associated with for the purposes of the read-out. Thus, read-out signals of the state of the qubits are multiplexed during read-out of charge using digital codes. The single-electron transistors are modulated and their output currents are summed, which allows the information of the N SETs to be available in a single wire.

The spread sequences have orthogonality properties or at least good correlation properties, which allows each sequence to be identified individually in a signal comprising all the spread sequences.

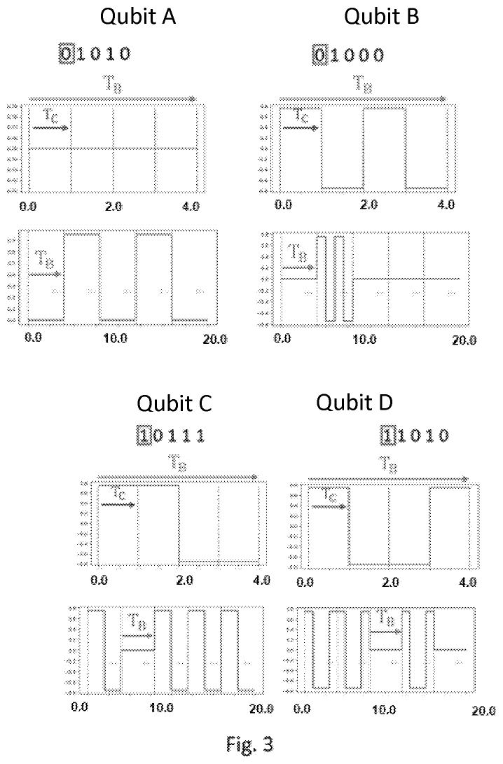

FIG. 3 This method allows a particular qubit to be recognised in a multiplexed read-out channel as a function of the code associated therewith. In order to show this mechanism, FIG. 3 shows the case of four qubits, with a spread sequence being associated with each qubit. These spread sequences are made up of 4 chip times (TC), which together form 1 bit time (TB). The modulation applied by the qubit data is of the OOK (on-off keying) type in accordance with the result of reading a single-electron transistor that allows through the modulated signal or does not allow it through depending on the current state of the qubit and its coupling thereto.

Therefore, the example in the figure shows that the data to be transmitted by each qubit reveals the spread sequence of the relevant qubit in the channel or, conversely, does not reveal the spread sequence. In the example of the qubit D in FIG. 3, it can be seen that its channel has a zero signal on the 3rd transmitted bit and on the 5th transmitted bit since the data to be transmitted is: [1, 1, 0, 1, 0]: there is a 0 in the 3^{rd} position and a 0 in the 5^{th} position.

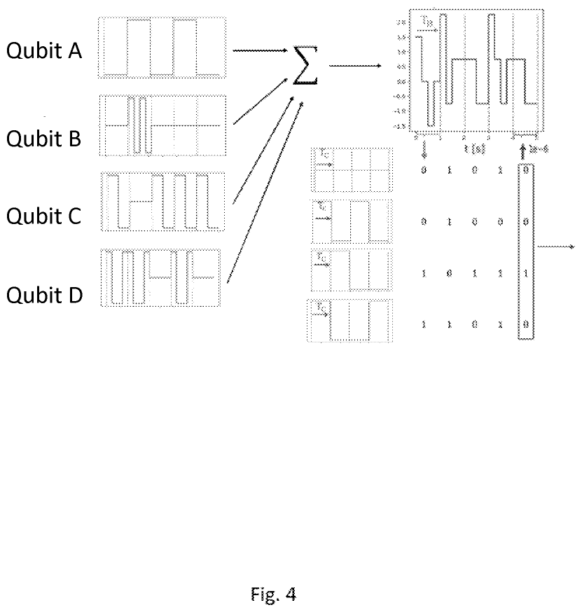

FIG. 4 develops the case of FIG. 3 and shows that if the sequences are synchronised with one another and then added in order to form a new signal, then the value of the bit transmitted by each qubit over each bit time TB within this aggregated signal can be known. In the example of FIG. 3 and FIG. 4, the spread sequences are selected according to the Hadamard matrix, which guarantees orthogonality properties between the sequences and very good autocorrelation, as well as the fact that these sequences are synchronous with one another. Thus, if, over a bit time TB, the aggregated signal is multiplied by the sequence of a qubit, and if the sequence of the qubit is present, the result is different from 0, whereas if the sequence is not present, the result is equal to 0.

The approach for finding a sequence in the aggregated signal or acknowledging its absence involves multiplying each element of the spread sequence (SE) by its corresponding element over the bit time of the aggregated signal and then summing all these products. This number, once divided by the number of channels in the signal, in this example n=4, is normalised between 0 and 1 and corresponds to the following equation, where it is denoted Cf (Correlation factor)

$$Cf = \frac{1}{n} {\sum }_{i = 0} SE [ i ] \cdot SumSignal [ i ] .$$

The spread sequences are continuously sent by the digital controller 200 shown in FIG. 2. The currents of the read-out transistors modulated by the associated qubits are then summed and sent to an amplifier.

In the case whereby the spread sequences that are used are orthogonal to each other, the signal is not degraded by inter-sequence interference. The orthogonality allows an optimal BER error rate to be maintained because the signal-to-noise ratio is only affected by the noise of the chain.

In the ideal case where the multiplexing does not degrade the SNR, the number of possible elements to be multiplexed using digital codes therefore is

$${N}_{code} = \frac{BW}{{F}_{read}} = \frac{{T}_{B}}{{T}_{c}} ,$$

with BW being the bandwidth of the system (dominated by the TIA amplifier), and Fread being the inverse of the read-out time sought by the system in order to obtain the value of the qubits.

This result is derived from the possible number of different orthogonal codes that can be generated. In the case whereby TB=N·TC (the ratio between the bit time and the chip time is N), the sequences of each qubit are all of length N and therefore in a space of dimension N. Therefore, it is possible to place N qubits in parallel without one sequence interfering with the others.

In the case of non-orthogonal sequences, the number of elements that can be multiplexed depends on the selected sequences, and can be high but at the cost of making various concessions, such as long sequences or even a high intercorrelation factor involving degraded noise performance capabilities.

The solution allows a large number of single-electron transistors to be read at the same time, with this number being substantially equal to the ratio of the system bandwidth to the read-out time. The spread sequences are generated cold in some embodiments. Only one frequency can be used, namely 1/TC=fc. Only the clock signal is to be supplied, and it can be generated hot.

The various blocks of a system capable of probing 16 single-electron transistors SETs at the same time in 1 μs using a modulation performed in the low temperature stage T0 will now be examined in further detail.

With further reference to the structure shown in FIG. 2, five functions for implementing the invention are listed. These include the generation of sequences for multiplexing using digital codes, scaling the digital signals for single-electron transistors, the pairs of transistors for reading qubits and associated qubits, an amplification chain for conveying all the signals to the demodulation block, and the demodulation function.

### Generation of Sequences

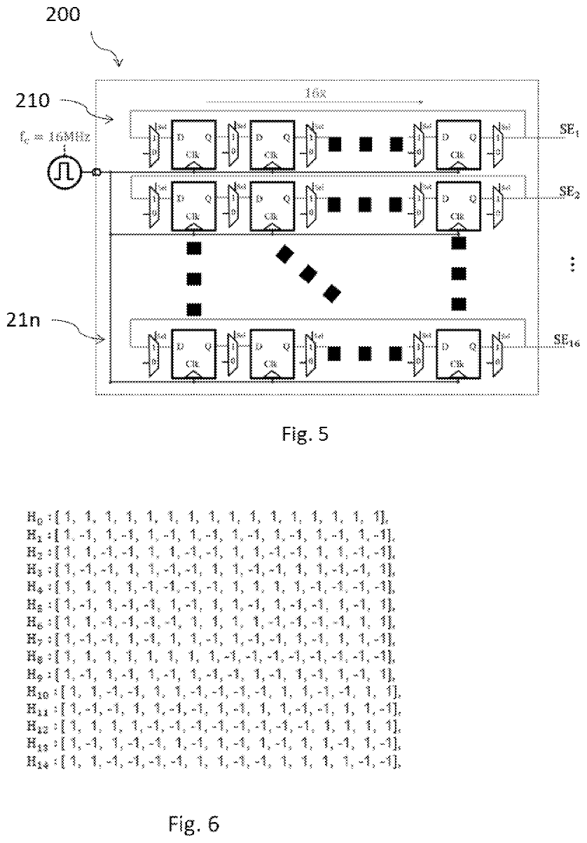

FIG. 5 In terms of the generation of the sequences for multiplexing using digital codes, the digital controller 200 of FIG. 2 is implemented in an embodiment, as shown in FIG. 5, with 16 shift registers 210, . . . 21n, each being 16 long. FIG. 5 shows the clock input fc=16 MHz supplied from outside, which clocks the circuit, as well as 16 parallel outputs, SE1 to SE16.

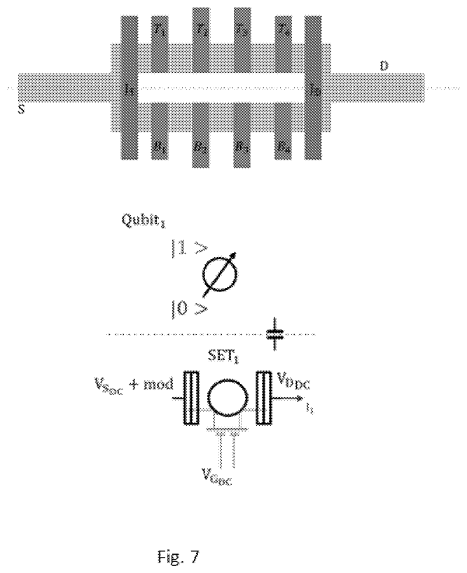

FIG. 6 In one embodiment, 16 mutually orthogonal sequences are generated, using a 16 by 16 Hadamard matrix, where each row of the matrix is identified by Hi, as shown in FIG. 6. These 16 rows are therefore made up of 2 levels (+1 and −1) and are orthogonal to each other.

In order to send these 16 sequences to the SET read-out transistors, 16 shift registers are pre-loaded via a network of multiplexers controlled by a selection signal “Sel” in FIG. 5. Each flip-flop j of the row i is pre-loaded with the element Hij of the Hadamard matrix. For example, the first row of the shift register is fully pre-loaded to 1. This can be optimised, but in this case it is possible to show an identical architecture for each sequence. Thus, as long as the selection signal “Sel” is in state 0, the outputs are all at 1 (first element of all the Hadamard rows), then when “Sel” transitions to 1, all the sequences run at the clock rate on the 16 parallel outputs.

The example was expressed using a Hadamard matrix that allows N sequences to be generated of length N, all orthogonal to each other under conditions whereby N is a power of 2. It is also possible to take subsets of the Hadamard matrix, such as 100 codes of lengths 128 all orthogonal to one another.

However, the Hadamard matrix is not the only means for generating mutually orthogonal digital sequences.

In one variant, Gold sequences are used. Gold sequences are sequences of lengths 2ⁿ−1, where n corresponds to the length of the shift register used to generate them. These sequences, unlike the Hadamard sequences, are periodic sequences 2ⁿ−1, which facilitates asynchronous transmission.

These sequences exhibit good autocorrelation and low intercorrelation, but they are not orthogonal like the sequences derived from the Hadamard matrix. They have a long period and a pseudo-random appearance.

The advantage of these sequences is their long period, which can avoid a synchronisation problem between transmission and decoding. In the case of applications where the demodulation is carried out hot and the signals rise from the bottom of the cryostat, these sequences with long periods simplify the measurement.

In one variant, Kasami sequences are used. Kasami sequences are non-orthogonal sequences with good autocorrelation rates.

The relationship between the length L of a Kasami sequence and the number of possible sequences K is: K=\sqrt{(L+1)}. In order to have 16 qubits, the length of the sequence is at least 255, and for a system such as that described above, which attempts to read in 1 μs, the digital frequency is 255 MHz.

Through these two alternative approaches for generating sequences for multiplexing using digital codes, the important mechanisms therefore can be described as: good autocorrelation of the signals, low intercorrelation (or even zero if the sequences are orthogonal), a ratio of the length of the sequence to the number of possible sequences that is as low as possible, and a high periodicity for the sequences in the case of a hot read-out. Sets of binary sequences meeting these criteria are used for the invention.

### Quantum Device

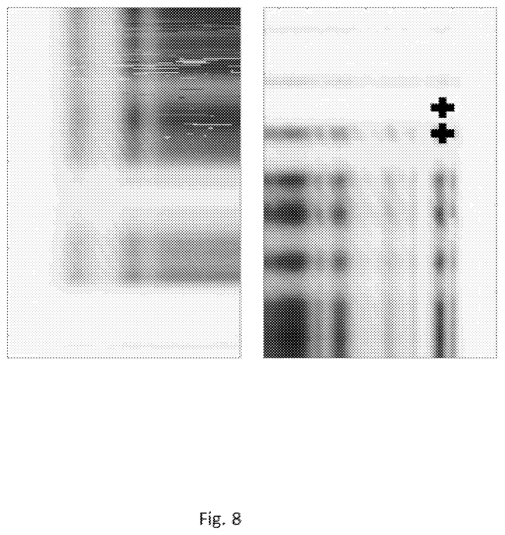

FIG. 7 The pairs of single-electron transistors for reading qubits and associated qubits can be constructed according to one embodiment with identical designs for the read-out transistor and the qubit. FIG. 7 shows an example of a device produced using semiconductor technology, in accordance with the article by B. C. Paz et al., entitled “FDSOI Platform for Quantum Computing”, 2024 IEEE International Electron Devices Meeting (IEDM), San Francisco, CA, USA, 2024, pp. 1-4. Two parallel conduction channels share a source S and a drain D with a space between them. The upper channel (T1 to T4) is, in one embodiment, used to perform the qubit function and the lower channel (B1 to B4) is then used as a detector, by accommodating the SET read-out transistors. Each channel is overlaid by several gates for precisely controlling the electrostatic wells in the channel. Each bit is capacitively coupled to its associated read-out transistor.

With respect to the read-out transistors that are modulated, the circuit generating the sequences for the multiplexing in FIG. 5 has a rail-to-rail output since it is directly at the output of the flip-flops. However, the read-out transistors need low amplitude modulation around a biasing point.

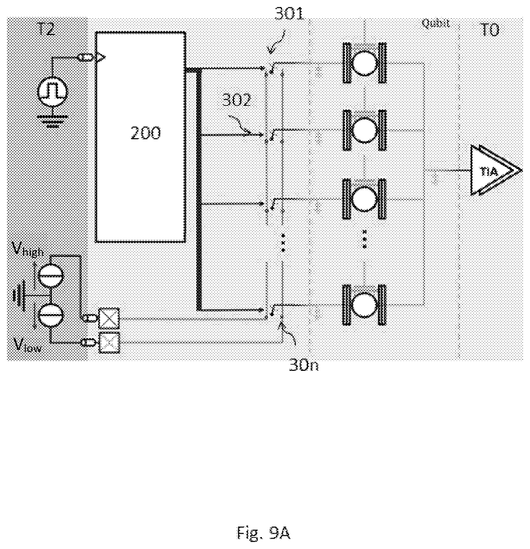

FIG. 8 shows the biasing mapping of two single-electron transistors, in this case an NMOS transistor (on the left) and a PMOS transistor (on the right), with double gates where the digital code modulation is applied.

Two gates are used and biased to the potentials VGS1 (on the abscissa) and VGS2 (on the ordinate) of FIG. 8. The regime of interest for a sensitive detector is, for example, between the crosses shown in FIG. 8. The regime of the read-out transistor (which therefore is or is not on a peak) also depends on the DC potential biasing points such as VGS1 and VGS22 and therefore on the drain-source voltage VDS. In this example, the modulation is performed by the source.

The digital code multiplexing described herein is applied to a read-out of charge and in particular to single-electron transistors reading respective qubits. Other quantum devices allowing read-out of charge, one parameter of which can be modulated by a signal, are used in variants.

### Scaling Digital Signals

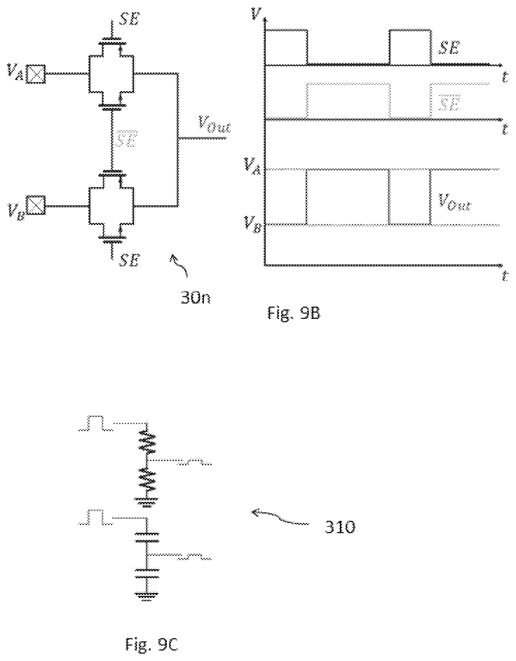

FIG. 9A The amplitude of the voltage modulation individually applied to each transistor so that it can be individualised is low and is dictated by the structure of the transistors. It can be the same for each transistor. In this case, this involves a few mV for the map shown in FIG. 8. However, the rail-to-rail modulation of the digital module has, in various embodiments, greater amplitude. A block allowing it to be returned to the desired amplitude at the input of the read-out transistor, involving scaling or levelling or even attenuation, is therefore used in one embodiment.

Two power supply voltages Vhigh and Vlow are generated hot, in the temperature stage T2, and one or the other is supplied to the read-out transistors via switches 301, 302, . . . 30n, individually controlled by the digital module 200 in order to form the spread sequence associated with the targeted transistor.

The switches controlled by the digital controller 200 switch the voltage added to the biasing point VS of the source of the read-out transistor.

In some embodiments, the map shown in FIG. 8 is considered to be liable to change over time. Therefore, provision is made to change the voltages Vhigh and Vlow.

The solution set forth above is that of a digital level converter: a digital signal with a certain amplitude is picked up at the input and propagates at the output at the amplitude of a different power supply.

FIG. 9A proposes a solution with switches. Alternative digital level converter architectures that meet the speed criteria and do not cause overconsumption are used in other embodiments.

In the example of FIG. 9, the levels used to modulate the read-out transistors receive the same two voltages Vhigh and Vlow, but in some variants this is not the case. In one variant, one of the two voltage levels is adapted to the relevant transistor and, in another variant, the two levels are adapted to the relevant transistor.

One embodiment uses a demultiplexer equipped with a sample and hold stage fed by an analogue-to-digital converter.

FIG. 9B A practical approach is shown in FIG. 9B. This shows the details of the switches shown in FIG. 9A, with the signals Va and Vb in FIG. 9B being analogous to Vhigh and Vlow in FIG. 9A. This approach involves the use of a pass gate transmission gate that allows the transitions completed by the digital module that provides the spread sequence SE to be reproduced with very precise levels VA and VB by forming the switch 30n. The equivalent resistance of the circuit in the gate on position is reduced, which is advantageous. This setup allows the digital square wave signal SE sent by the digital module to be reproduced, as well as its opposite SE at different externally generated voltages.

FIG. 9C A similar variant is shown in FIG. 9C and uses passive dividers 310 (resistive or capacitive). In one variant, the division ratio is a controlled ratio.

### Amplification

In terms of amplification, with the read-out transistors that are used being modulated by the source in this example, the amplification scheme that is used is a TIA transimpedance amplifier. This solution benefits from the fact that the outputs of the read-out transistors are in current, which allows them to be easily summed and then amplified into a voltage. A C-TIA (capacitive transimpedance amplifier) can be used.

The TIA has sufficient gain of the order of 60 dB and a bandwidth allowing the modulation of the signals to pass; for a clock frequency of 16 MHz, the cut-off frequency of the TIA is at least 16 MHz.

The amplifier or amplification chain is used to convey the signals to the demodulation block.

The C-TIA amplifier is replaced, in some variants, with a push-pull TIA architecture, a cascode TIA architecture, a resistive TIA or a shunt-feedback TIA architecture. The constraint in terms of the signal-to-noise ratio at the output and in terms of bandwidth is respected with regard to the selected architecture. The choice of topology is made according to the sizing of the gain chain, the desired BER error rate, the reading speed and the consumption.

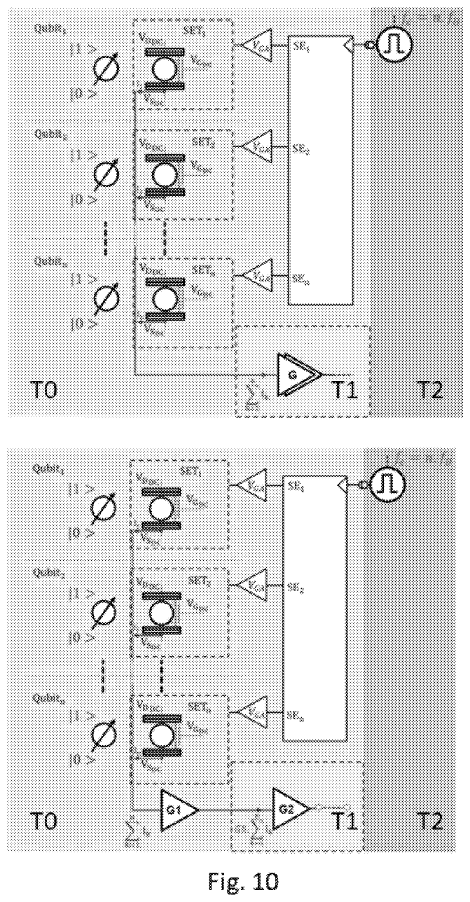

FIG. 10 Various temperature locations are used, as shown in FIG. 10, the upper part of which shows the amplification block G fully set to a temperature that is not the operating temperature of the qubits T0 but is an intermediate operating temperature T1 distinct from T0 and T2, and is somewhere between these two values. This allows the consumption constraints on the amplification block to be reduced.

Another implementation is shown in the lower part of FIG. 10 with an amplification block G1 at a low temperature T0 and another amplification block G2 at a higher but intermediate temperature T1. This provides a first very low noise gain block that reduces the noise constraint of the second block.

In some variants, current amplification schemes with a suitable demodulation chain are used, such as, for example, with an analogue-to-digital converter that converts a current (its input) into a digital word to be processed by the digital demodulation chain described above.

Finally, in one variant, no amplification is implemented, with the signal being able to be exploited directly.

### Demodulation

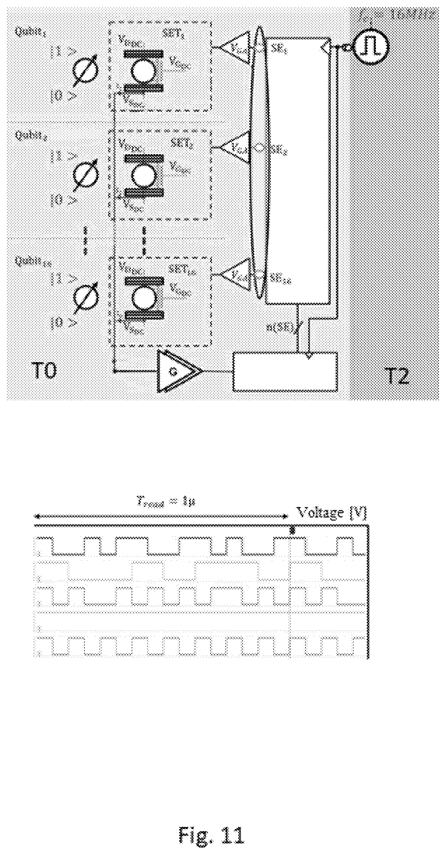

FIGS. 11, 12, 13 and 14 show the various signals and their location in the circuit.

FIG. 11 shows the signals output from the digital controller shown in FIG. 5 (marked by an oval frame on the circuit at the top of the figure) that is applied to the read-out transistors. The length of a spread sequence Tread 1 μs is indicated on the time axis, namely the abscissa axis. The ordinate axis represents the voltage, since the signals output from the digital controller are voltage signals. Five sequences are shown from top to bottom in the lower part of the figure.

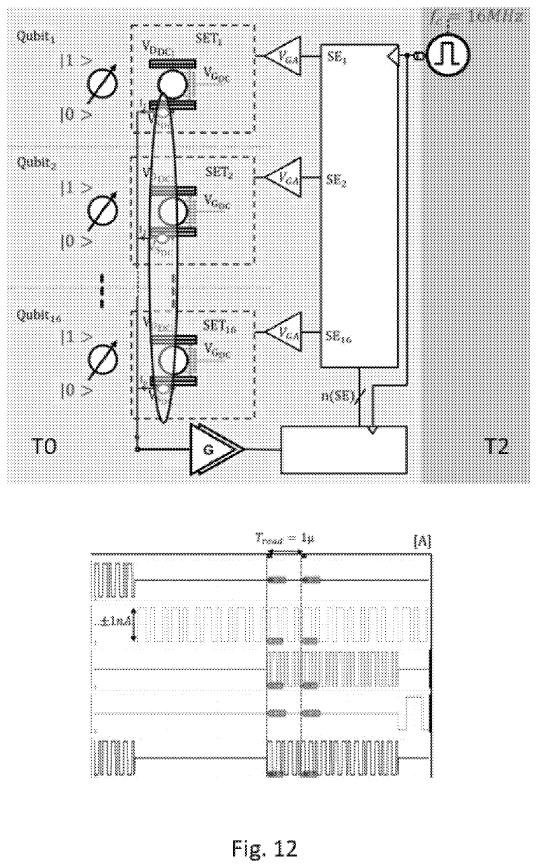

FIG. 12 shows the modulated currents output from the read-out transistors (marked by an oval frame on the circuit at the top of the figure). The length of a spread sequence Tread 1 μs is again indicated on the time axis, namely the abscissa axis on the graph as a function of time depicted in the lower part of the figure. The ordinate axis represents the current, since the output of the read-out transistors is a current. The output signals of five transistors are shown from top to bottom in the lower part of the figure. The amplitude of the currents is of the order of 1 nA.

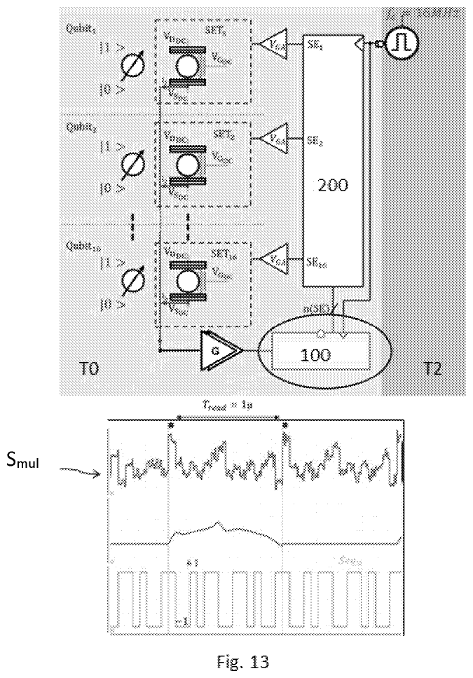

FIG. 13 relates to the signal conveyed to the demodulation block 100. This signal results from the sum of all the currents produced by the read-out transistors, aggregated on a single row, with this sum then being amplified by the amplification chain and sent in this amplified form to the demodulation block 100 (block marked with an oval frame on the circuit at the top of the figure).

The length of a spread sequence Tread 1 μs is again indicated in the lower part of the figure, on the time axis, namely the abscissa axis. The ordinate axis represents the signal. The spread sequence of a particular transistor seqH is shown in the lower part of the graph—it is a square-wave signal between the values −1 and 1, with only two levels, succeeding one another no faster than the chip time. The length of the spread sequence Tread is equal to the bit time and sequences are clocked to the chip time and the periodic of the bit time (or Tread). The sequences sent by the block shown in FIG. 5 are transmitted to the demodulation module 100 with low latency by the digital controller 200 using a link n (SE) indicated on the circuit in the upper part of the figure. The upper part of the graph shows the signal conveyed to the demodulation block 100: it is a signal SmuI covering many different levels, but it is nevertheless possible to recognise superimposed square waveforms succeeding one another at the rate of the chip times.

In order to perform the demodulation, the sequence seqH is multiplied by the signal SmuI and is integrated over the read-out time Tread. The curve in the middle of the graph in FIG. 13 shows the result of this operation as a function of time. In this particular case, the integration tends towards the value of 0 at the end of the integration interval, indicating that the sequence is not present in the examined signal.

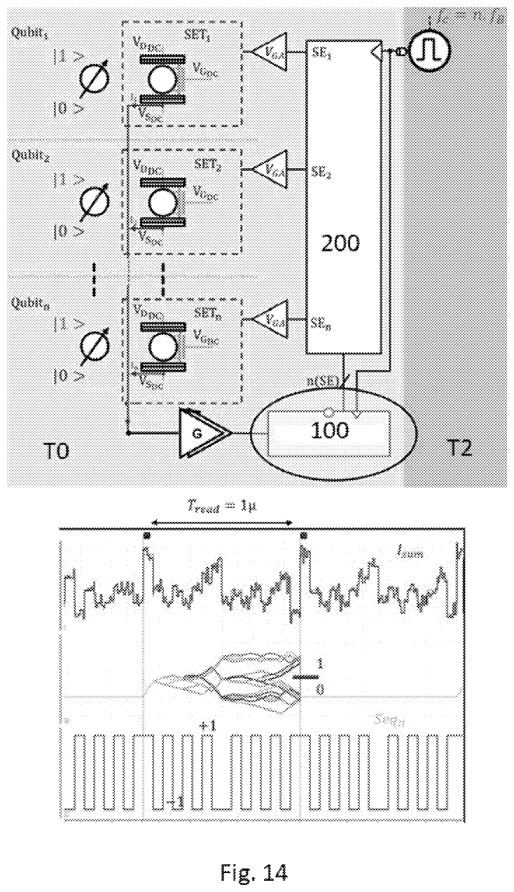

FIG. 14 shows the same process as FIG. 13, but with the results of integrations and multiplications of 16 superimposed sequences. It can be seen that some of these results tend towards 1—they correspond to the sequences contained in the signal—and towards 0 for others, when the sequence is not contained in the signal. A detection threshold is set between the two values of 0 and 1 and allows the state of each read-out transistor to be known and therefore allows the state of each qubit to be known according to the proximity between the final value of the integration and the values of 0 and 1.

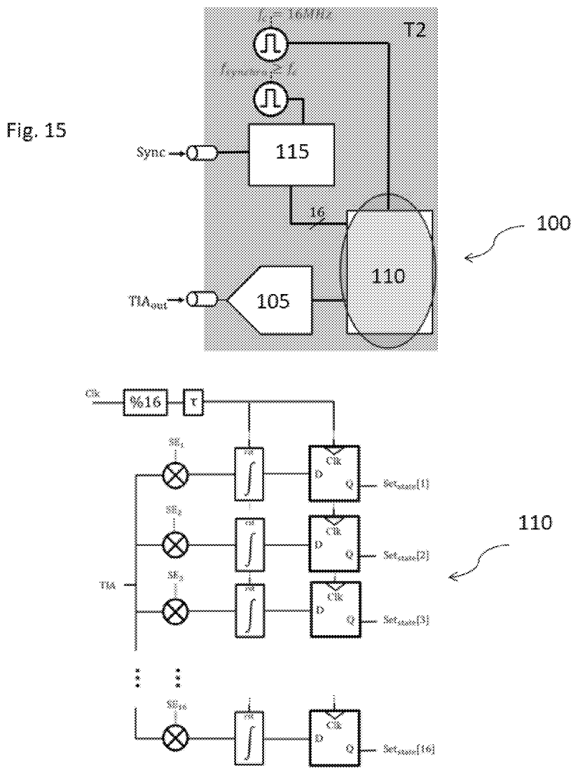

FIG. 15 In order to perform the demodulation function, various approaches are used in various embodiments.

For example, FIG. 15 shows a hot demodulation module 100 (at the temperature T2) made up of an analogue-to-digital converter ADC 105 that digitises the signal output from the amplification chain (located by reference TIAₒᵤₜ) and a digital subsystem 110 performing the multiplication and the integration. Hot generation of the spread sequences requires synchronisation with the cold stage. It is carried out by a sequence generator 115. The synchronisation allows the bit time to be recovered.

The detailed diagram in the bottom right of FIG. 15 shows the signal amplified by the amplification chain (located by reference TIA) and digitised by the analogue-to-digital converter ADC 105 that is applied in parallel to 16 demodulation channels.

This signal is initially multiplied on each of these channels by one of the 16 spread sequences (SE1, . . . SE16).

The hot-generated clock is divided by 16 and phase shifted in order to compensate for the time shift caused by the cable length and the propagation of the spread sequences from the lower temperature stage. This clock, which is divided and phase shifted in order to correspond to the 1 μs windows of the spread sequences, controls the integrators that are reset at the beginning of each new read-out. At the output, the state of the integrators is saved immediately before the reset. All the computations are completed in accordance with the number of bits of the analogue-to-digital converter, which in this case, by way of an example, is designed around 6 bits (the analogue-to-digital converter has sufficient resolution so as not to degrade the measurement and the digital subsystem is designed according to the resolution of the analogue-to-digital converter). The information output from the digital subsystem 110 of the demodulation module 100 is directly the state of the read-out transistor, for each transistor.

The demodulation chain is, in another variant, an analogue chain.

The recomposition of the sequences is carried out at a higher frequency than the chip time. The recomposition frequency of the spread sequences corresponds to the maximum error that occurs. If f_{synchro}=10*f_{c}, then the error at worst is one tenth of a chip time between the hot and cold spread sequences.

The demodulation function, optionally including the conversion to a digital signal, can be partitioned within the temperature stages. This temperature partitioning overcomes any bandwidth constraints justifying digitisation at a low temperature or at an intermediate temperature in order to reduce any connection interference. Cold demodulation is justified in some variants by synchronisation constraints, with some correction algorithms such as the surface code requiring a short reaction time on the qubits to be corrected. Causing the cold demodulation allows this counter-reaction time to be reduced through the propagation gain in the cables (approximately 5 ns/m of cable) and through faster dedicated electronics.

The functions that are set to hot conversely do not require specific development to the cryogenic conditions, and do not have consumption or surface constraints. Thus, in a variant, the digital demodulator is set to the temperature T2, while the analogue-to-digital converter is set to the temperature T0.

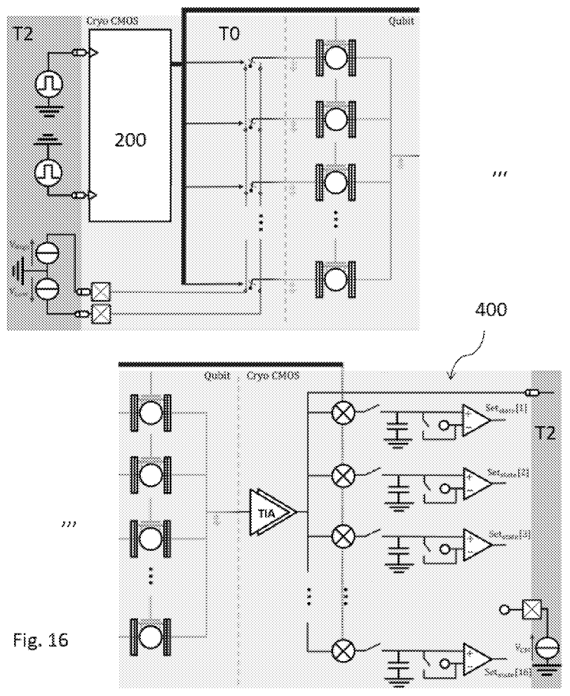

FIG. 16 In some variants, analogue demodulation replaces digital demodulation, and then there is no analogue-to-digital converter. This reduces the equivalent consumption of the circuit.

A diagram of an analogue demodulation chain 400 is shown in FIG. 16, where the demodulation is performed cold (at the temperature T0). The signal modulated by digital codes is amplified, for example via a transimpedance amplifier (TIA), and this signal is then simultaneously transmitted to 16 mixers. These mixers combine the signal transmitted by the transimpedance amplifier with each of the 16 cold-generated sequences. If the mixers produce a current, this current propagates through a capacitor that has been pre-loaded to a common mode voltage. Therefore, the current is integrated into the capacitor as a voltage during the read-out time (1 μs in the example in the previous section), before being compared to the common mode voltage the capacitor was pre-loaded at, which provides digital information per transistor.

Therefore, the architecture shown in FIG. 16 allows cold reading of the read-out transistors since the state of the read-out transistors is digitised at the output of the demodulation chain. This solution allows an integrated architecture to be produced in order, for example, to perform time multiplexing between various cores or multicore computing.

### SerDes Serial Link to the Outside of the Cryostat

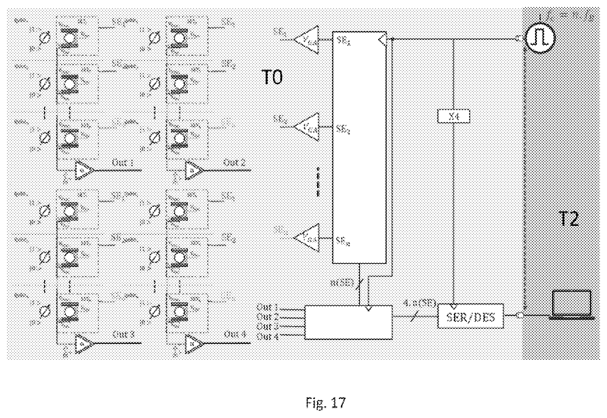

FIG. 17 In some embodiments, a cold high-speed serial link allows all the data to be extracted from the cryostat over a single cable. The series data is transferred at the chip frequency f_{c}, that is n·f_{B}, which allows n qubits to be read.

FIG. 17 shows four channels of n single-electron transistors each. These four channels are identical: they receive the same n spread sequences in order to modulate the n transistors they are associated with. However, the quantum data is different, but the operation is the same.

The digital modulation means are pooled, since the n spread sequences are the same for all. The four amplifiers of the four channels each form an output. A demodulation block capable of processing four amplifier outputs in parallel is implemented. Alternatively, the demodulation block is duplicated four times for a single channel, as mentioned above.

The example shown involves resuming outputting serial data outwards. Since there are four channels, the output frequency is a frequency that is equal to 4 times the chip frequency. A cold frequency multiplier is set up. Only two cables run through the cryostat enclosure.

Depending on the frequencies and the dissipated energy, in some variants this frequency multiplier is replaced by a cable for the frequency of the serial output.

1. A quantum device comprising a plurality of spin qubits (Qubit1, . . . Qubitn), a cryostat containing said qubits, electrometers (SET1, . . . SETn) each coupled to one qubit of the plurality of qubits in order to extract, for each qubit, a read-out signal of a current state of the qubit, a voltage generation module generating a plurality of voltages for exciting said electrometers with modulations specific to each electrometer, and a transmission line for transmitting an aggregated signal originating from the electrometers, said aggregated signal being processed by a demultiplexing module of the quantum device in order to recognize, through demodulation, the current states of the qubits of the plurality of qubits, the quantum device wherein the voltage generation module generates periodic sequences (SE1, . . . SEn) clocked at a reference frequency (fc), with said generated periodic sequences being distinct from one another and being used to excite the electrometers in a differentiated manner, the demultiplexing module accessing the current states of the qubits using said reference frequency (fc) and said periodic sequences (SE1, . . . SEn).

2. The quantum device according to claim 1, wherein the periodic sequences (SE1, . . . SEn) are mutually orthogonal sequences.

3. The quantum device according to claim 2, wherein the periodic sequences are Hadamard sequences or pseudo-noise generated sequences.

4. The quantum device according to claim 1, wherein the periodic sequences (SE1, . . . SEn) are Gold sequences, with the demodulation being performed hot.

5. The quantum device according to claim 1, wherein the periodic sequences (SE1, . . . SEn) are generated by the voltage generation module inside the cryostat.

6. The quantum device according to claim 1, wherein the demultiplexing module proceeds, sequence-by-sequence, by integrating the aggregated signal multiplied by the periodic sequence over a read-out time common to the various sequences, in order to recognize the presence or the absence of the periodic sequence in the aggregated signal.

7. The quantum device according to claim 1, wherein the aggregated signal is previously processed by a digitisation module for the purposes of demodulation by the demultiplexing module, or the aggregated signal is demultiplexed inside the cryostat by an analogue circuit comprising a capacitor and a comparator for each qubit.

8. The quantum device according to claim 1, wherein the quantum device comprises voltage levelling modules for matching voltages delivered by a digital voltage generator of the voltage generation module to the biasing points of the electrometers, with each levelling module comprising a controlled switch for alternating between two DC voltages, or a resistive or capacitive voltage divider.

9. The quantum device according to claim 1, wherein the voltage generation module generates digital codes on two levels.

10. The quantum device according to claim 1, wherein the voltage generation module comprises one shift register per qubit of the plurality of qubits for the purposes of generating the various periodic sequences.

11. The quantum device according to claim 1, wherein the voltage generation module is pooled for several pluralities of n qubits, with the same n periodic sequences being used for each plurality of qubits, with said pluralities of qubits each being associated with a specific aggregated signal.

12. The quantum device according to claim 1, wherein the electrometers are single-electron transistors modulated by the source or the gate.

13. The quantum device according to claim 1, wherein the qubits and the electrometers are constructed face-to-face in a semiconductor material.

14. The quantum device according to claim 1, wherein the generated periodic sequences are delivered to the demultiplexing module in the cryostat by the voltage generation module, or outside the cryostat by a module synchronized with the voltage generation module.

15. The quantum device according to claim 1, wherein the reference frequency (fc) is supplied within the cryostat to the voltage generator by a clock signal generator outside the cryostat.
